(19) United States
(12) Patent Application Publication
(10) Pub. No.: US 2007/0172787 A1
(43) Pub. Date: Jul. 26, 2007

(54) Method for production of a dental fitting body

(76) Inventor: Peter Fornoff, Reichelsheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/578,730

(22) PCT Filed: Apr. 21, 2005
(86) PCT No.: PCT/EP05/51762

§ 371 Date: Oct. 18, 2006

(30) Foreign Application Priority Data
Apr. 23, 2004 (DE) 10 2004 020 369.5

(51) Int. Cl. A61C 3/00

(52) U.S. Cl. 433/3

(57) ABSTRACT

The invention relates to a method for the production of a tooth prosthetic piece (21), in particular, a skeleton, using a blank (3) for machining in a material ablating 3D-forming process, said blank being made from a material not yet having the final hardness, comprising a terminal hardening of the formed piece (2) produced during the forming process to give a formed piece (2′), with the final hardness, whereby the 3D forming process is divided into coarse machining process for the blank (3) and a precise finishing process for the formed piece (2′) with the final hardness, in order to give the final form of the tooth prosthesis piece (21). The invention further relates to a mount or mounting set for carrying out the method in said particular fashion, comprising connectors for mounting the blank and suited to the shrinkage factor of the fixed formed piece. A further aspect of the invention concerns a formed piece, which, in addition to the usual over-dimension, has a further over-dimension including the tolerance range for the material shrinkage and the machining process.

### TECHNICAL FIELD

The invention relates to a method for the fabrication of a dental prosthetic item, for example, frame structures such as dental copings or bridges, on the basis of high strength, brittle materials, especially ceramic materials such as zirconium oxide and aluminum oxide or sintered metals.

Such materials are not imparted with their ultimate strength properties until a second process step is carried out, for example a sintering process, in the case of ceramic material.

### DESCRIPTION OF THE RELATED ART

In the methods disclosed in the prior art, restorations are produced by process steps carried out as follows.

First of all the blank is manufactured. To this end, the raw materials for a batch are produced, and then the mill blank is manufactured by compressing the raw material. Finally, the sintering shrinkage parameters of typically 25% for the batch are defined. Sintering shrinkage parameters vary from batch to batch typically within a tolerance range of ±2%.

The sintering shrinkage parameters for individual batches can be determined by a laborious procedure with a degree of accuracy typically ranging from 0.1% to 0.2%; the batches can be designated accordingly.

Furthermore, a blank with a connecting geometry for attachment thereof to a holder is known from the manufacture of implants.

Then the restoration is manufactured, which involves making an impression of the situation to be restored in the patient's mouth and subsequently producing a scan model. This is followed by 3D scanning of the model and designing the restoration by CAD/CAM methods. Once the design data are obtained, a suitable blank is selected and the sintering shrinkage parameters of the selected blank are imported. The design data are adjusted with reference to the sintering shrinkage parameters to suit the selected blank prior to 3D machining thereof. Following carving, a shaped part is produced which is further processed, in the case of ceramics by sintering, to achieve its ultimate strength properties. Finally, this shaped part having its ultimate strength properties can be veneered with veneering ceramics.

The disadvantages of this method are that exact process control is required for the manufacture of the blank, a process step is required to determine the shrinkage parameters, and high demands are placed on the sintering process. Systems available on the market show that the sum of all of the errors arising from the process steps can lead to considerable deviations in the dental prosthetic items produced, which prosthetic items are generally in the form of a framework.

### SUMMARY OF THE INVENTION

According to the invention, the 3D shaping operation is divided into a coarse machining operation on the blank and a precision finishing operation on the shaped part having its ultimate strength properties, for the production of the final shape of the dental prosthetic item.

The advantage thereof is that minimal demands with respect to precision are placed on the first 3D shaping operation and the process used for achieving ultimate strength properties. Only the dimensional deviations need to be corrected during the finishing operation.

In order to be machined, the blank is advantageously attached to a holder having a first connecting geometry, which is designed such that the blank in its uncompacted form can be mounted in a defined position.

Along with the sintering shrinkage parameters, the coarse machining operation can advantageously be such as to provide oversizing in order to cover the entire tolerance range of the fabrication of the dental prosthetic item, in other words the tolerance band of a batch.

In this manner, the process of defining the sintering shrinkage parameters of the batch as well as the importing of the parameters prior to each machining step can be omitted. Due to the low tolerance band of ±2%, with typical restorations of ±20 mm in length there is only an excess of ca. ±400 μm in the direction of the largest dimension. Consequently, this also leads to simplified process control for the manufacture of the raw material for the blank.

Advantageously, the degree of oversizing is collected dependent on to a local position on the shaped part having its ultimate strength properties.

Since the shrinkage caused during sintering is substantially homogeneous, the degree of oversizing can be calculated starting from the center of the shaped part relative to the distance from the center, and the shape of the shaped part can thus be further largely approximated to the shape of the dental prosthetic item.

During coarse machining, an unmachined residual region is advantageously left on the blank in the vicinity of the holder. This achieves stable attachment of the coarsely machined shaped part to the holder during further machining operations.

The shaped part advantageously remains on the residual block during the coarse machining operation in order to provide a positioning aid for repositioning.

In another advantageous embodiment, a precise reference block is formed on the blank or produced on the shaped part during the coarse machining operation.

According to a further development, the machining data for the finishing operation can be acquired by measuring the reference block on the shaped part or the blank. The shaped part and the reference block are sintered during the sintering operation. The position of the reference block relative to the blank is known to the control software. After sintering, the reference block or blocks reproduce the exact shrinkage parameters in all directions in space. The measurement of the reference block imparted with the ultimate strength properties takes place inside the machining unit, preference being given to an optical operation or a modified tool-tactile operation. The machining schedule is generated from the measured shrinkage parameters. Such measurement can take place outside the unit, if desired.

The errors in the entire process chain are thus corrected, ie, the additional adjustment effort required on the part of the dental technician is minimal.

The shaped part imparted with its ultimate strength properties is advantageously attached to a holder with a connecting geometry that takes the shrinkage parameters into account. Secure attachment is thus ensured for the finishing operation and the shaped part imparted with the ultimate strength properties assumes a precisely defined position relative to the machining tools.

According to a further development, the machining data for the finishing operation can also be obtained by scanning the shaped part after it has been imparted with the ultimate strength properties. The machining schedule is generated from the comparison of these data with the original scanned data. The machining schedule can thus be optimized to allow for criteria such as high speed, high precision, or low wear on the tools. Scanning can be achieved by means of a scanning device on the machining unit or outside the machining unit.

In both types of scanning operations, exact repositioning of the pre-fabricated restoration on the block holder is not absolutely necessary.

According to an advantageous development, scanning of the shaped part imparted with the ultimate strength properties is undertaken only in certain regions that require a high degree of precision. Finally, a comparison of these scanning data with the coarse machining data is used to generate the machining schedule for the finishing operation, allowance being made for the shrinkage parameter acquired from the comparison. The advantage in the acquisition of the shrinkage parameter is that shorter scanning times are made possible.

Since the final shaping of the occlusal regions, the wall regions, and the connecting links is carried out during veneering with veneering ceramics when frameworks are used in the manufacture of dental prosthetic items, in some cases the oversizing used in said regions is tolerable and no machining is necessary to achieve the calculated ultimate dimensions.

In such cases it is advantageous for scanning of the shaped part imparted with the ultimate strength properties to take place only in these regions.

Thus to produce a framework during the finishing operation, it is in some cases sufficient to machine only the following regions: the internal mating surface of the dental coping and the mating surface in the region of the preparation border.

The removal of the shaped part imparted with the ultimate strength properties from the residual region advantageously takes place during the finishing operation, so that the shaped part assumes a precisely defined position relative to the machining tools during the entire machining operation.

An advantageous development of the method includes scanning of the shaped part imparted with the ultimate strength properties by means of a scanning device on the machining unit. On the one hand this saves time, as the shaped part does not have to be mounted in some other device and on the other hand it contributes to the precision of the operation in that accidental misalignment of the shaped part on the holder is avoided.

Another aspect of the invention relates to a holder set that comprises at least two holders, of which each holder has a connecting geometry for an item to be held therein, a first holder has a connecting geometry for a blank not imparted with the ultimate strength properties and a second holder has a second connecting geometry for a shaped part imparted with the ultimate strength properties that has been produced from the blank by machining followed by a compacting operation, wherein said first and second connecting geometries differ from each other by the shrinkage parameters of the blank that will be incurred in the final compacting operation.

Furthermore, the invention relates to a holder for a blank not imparted with the ultimate strength properties and for a shaped part imparted with the ultimate strength properties, wherein a first connecting geometry for said blank not imparted with the ultimate strength properties and a second connecting geometry for said shaped part imparted with the ultimate strength properties that has been produced from the blank by machining, are provided, wherein said first and second connecting geometries differ from each other by the amount of shrinkage of the blank that will be incurred in the final compacting operation.

Such a holder set or such a holder presents a very good foundation for the implementation of the method proposed by the invention.

A final aspect of the invention relates to a shaped part for producing a dental prosthetic item, wherein said shaped part consists of a material not yet having its ultimate strength properties and which is machined from a blank so that it approximates the final shape but is oversized to allow for the shrinkage that will be incurred by the final compacting operation and that covers the tolerance range of the 3D shaping of said dental prosthetic item and preferably includes the tolerance band of each batch of blanks.

An advantageous development of the shaped part has a reference block of known position and dimensions.

The reference block can serve for the measurement of the shrinkage parameters of the shaped part prior to and/or after sintering, because, as a first approximation, the sintering operation causes homogeneous shrinkage throughout the material.

A final advantageous development consists of a shaped part that includes a positioning aid on a holder on the unmachined region of said shaped part or on which said positioning aid is produced from the blank during the manufacture of a shaped part by means of a 3D shaping operation. This simplifies the exact positioning of the shaped part in the machining unit.

### BRIEF DESCRIPTION OF THE DRAWINGS

The method of the invention is explained below with reference to the drawings, in which

FIG. 1 shows a shaped part attached to a holder following the coarse grinding operation and prior to the final compacting operation,

FIG. 2 shows a precision-ground dental prosthetic item having its ultimate strength properties immediately after removal from the holder,

FIG. 3 is a diagrammatic representation of the oversizing used after coarse grinding,

FIG. 4 shows the special scanned regions requiring a high degree of mating precision in the finishing operation,

FIGS. 5a to 5b show a holder set for holding the workpiece prior to and after the compacting operation, and

FIG. 6 shows a holder with two holder geometries.

### DETAILED DESCRIPTION OF EXEMPLARY EMBODIMENTS OF THE INVENTION

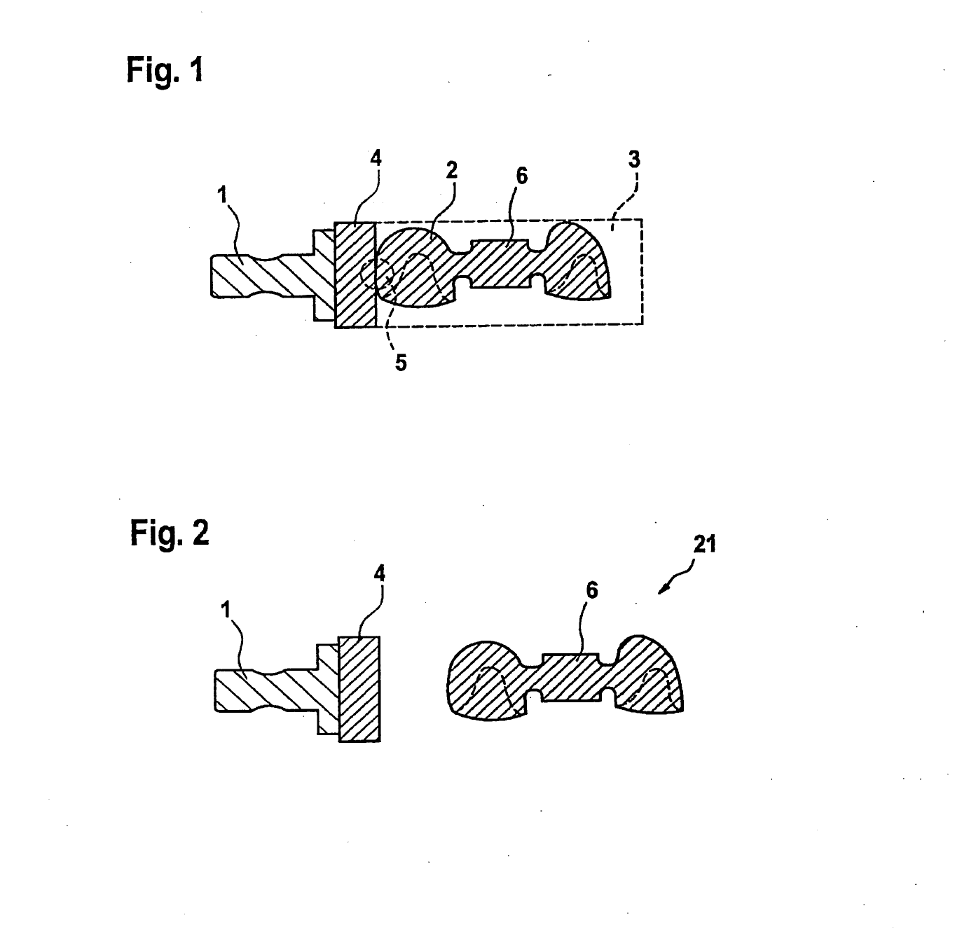

A shaped part 2 attached to a holder 1 is shown in FIG. 1. The shape of the shaped part 2 has been obtained in the actual exemplary embodiment in the course of a coarse grinding operation from a blank 3 represented by the dashed line by machining, for example, grinding or milling, and in its outer shape it already substantially corresponds to the dental prosthetic item to be manufactured. An unmachined residual region 4 of the shaped part is present in the transition region between the shaped part 2 and the holder 1. There is still a physical connection afforded by the connecting region 5 between the residual region and the shaped part 2.

Furthermore, a reference block 6 is provided on the shaped part shown, said reference block serving for the exact measurement of the shaped part prior to and after the compacting operation in order to determine the shrinkage parameter Xₛ in all directions in space.

Parts of the structure represented in FIG. 1 (shaped part with reference block as well as residual region+connecting region) will be subjected to a compacting operation after the coarse machining operation, which compacting operation usually comprises sintering at high temperatures. The material of the blank 3 or of the shaped part 2 is thus imparted with the desired ultimate strength properties. During sintering, the shaped part 2 and the residual region 4 shrink according to the shrinkage parameters Xₛ established in respect of the blank, which in turn have a tolerance Tₛ for the batch.

By sintering, the shaped part 2 is converted into the shaped part 2′ (not shown) having its ultimate strength properties, which is still to be finished.

In FIG. 2 the dental prosthetic item 21 produced from the shaped part (FIG. 1) immediately after removal from the residual region 4 located on the holder is shown. Prior to removal, finishing of the shaped part 2′ having its ultimate strength properties takes place at the necessary sites until the desired dimensions are achieved.

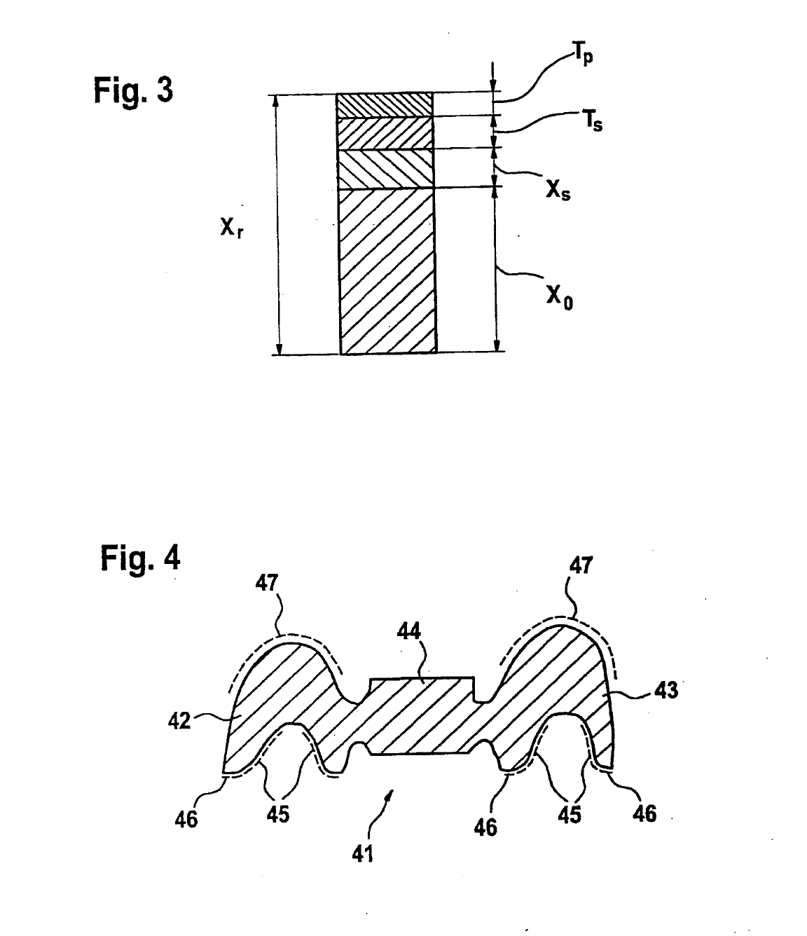

In FIG. 3 the tolerance ranges to be observed starting from fundamental dimensions Xₒ of the finished dental prosthetic item having its ultimate strength properties, which ideally coincides with a calculated measurement, are given. The oversize Xₛ required owing to the shrinkage parameters and which lies within an order of magnitude of from 1 to 30%, must first be corrected.

The shrinkage parameters of the material of the blank fluctuate from batch to batch within a certain range, which is typically 2%.

Furthermore, the manufacturing tolerances resulting from the manufacturing method, which can lie within a range of from 5 to 100 μm, are taken into account.

The sum of all of the parameters yields a rough size Xᵣ resulting from the production of the shaped part 2.

After sintering, the oversize that must still be machined off has decreased by the amount defined by the shrinkage parameter Xₛ, so that only the residual oversize needs to be removed, at least at the sites that are relevant.

Such sites are identified for a framework in FIG. 4. These are the internal mating surface 45, the surface 46 mating with the preparation border, and the external surfaces of the dental copings 47. The framework 41 represented as an example of a dental prosthetic item is a three-unit restoration and consists of two dental copings 42, 43 and the connecting link 44. The internal mating surface 45, the surface 46 mating with the preparation border, and the external surfaces 47 of the dental copings require very accurate machining, so that final carving of the dental prosthetic item is carried out in at least these regions.

Depending on the dental prosthetic item, however, it may even be necessary to subject the entire dental prosthetic item during the final carving operation.

Scanning of the shaped part having its ultimate strength properties can be performed either optically in the manner already known from dental grinding units or by a modified tool-tactile operation within the machining unit.

The grinding schedule for the ultimate grinding operation is generated from the measured shrinkage parameters.

Of course, the sintered shaped part can be scanned optically outside the machining unit. Compared with scanning using a point sensor or a tool-tactile operation, such scanning has the advantage in that it is much quicker. An intra-oral scanning camera is particularly well suited for this purpose. In order to take full advantage of the measuring range of such a camera, an appropriate scanning device for the camera and for the shaped part to be scanned can be provided. In this manner the risk of camera shake is avoided, on the one hand, while on the other hand it is possible to discern clearly the region in which scanning can be performed. In restorations of considerable length, a plurality of scanned data sets can be combined with each other in a manner suitable for the generation of an overall data set.

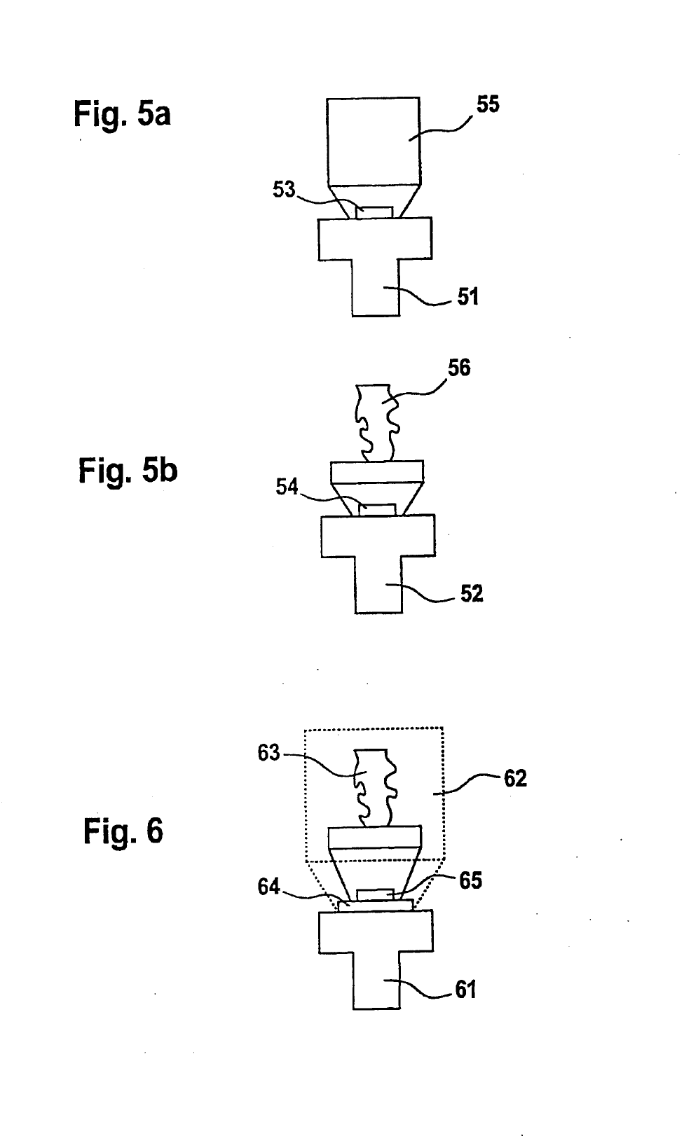

FIGS. 5a and 5b show a holder set comprising the holders 51 and 52. The illustrated holders 51 and 52 have connectors 53, 54 that accommodate a workpiece. The connector 53 of the holder 51 is configured so that a blank 55, in which the material has not yet been imparted with the ultimate strength properties, can be fastened thereon. After the shaped part has been coarsely machined from the blank and subsequently sintered, all parts of the material shrink to approximately the same extent. It is therefore necessary, for additional machining, to use a holder 52 with a connector 54, of which the connecting geometry is reduced in size relative to the connector 53 by the shrinking factor. The dental prosthetic item 56 can be held thereon in an exactly defined position.

A holder is shown in FIG. 6, which can accommodate the blank 62 (represented by the dashed lines) for coarse machining as well as the dental prosthetic item 63 after ultimate strength properties have been imparted thereto. The connecting region is thus configured with two steps and has a first connector 64, on which a second, smaller connector 65 is located. The connecting region of the blank 62 must therefore be accordingly configured so that it fits over the accessory connector 65. After the compacting operation, the shaped part 63 that has shrunk by the shrinkage factor can be placed on the appropriately configured connector 65 and subjected to a finishing operation to produce the dental prosthetic item.

### REFERENCE NUMERALS AND PARTS LIST

1 Holder
2 Shaped part
2′ Shaped part having its ultimate strength properties
3 Blank
4 Residual region
5 Connecting region
6 Reference block
21 Dental prosthetic item
41 Framework
42, 43 Dental copings
44 Connecting link
45 Internal mating surface
46 Preparation border
47 External surface of dental coping
51, 52 Holders
53 Connector with a first geometry
54 Connector with a second geometry
55 Blank
56 Shaped part having its ultimate strength properties
61 Holder
62 Blank
63 Shaped part having its ultimate strength properties
64 Connector with a first geometry
65 Connector with a second geometry

1.-22. (canceled)

23. A method for the production of a dental prosthetic item (21), particularly a framework, using a blank (3) made of material not yet provided with its ultimate strength properties and intended for machining in a material-removing 3D shaping operation, comprising a final compacting operation on the shaped part (2) resulting from said shaping operation, in order to convert it to a shaped part having its ultimate strength properties, the 3D shaping operation being divided into a coarse machining operation on said blank (3) and a precision finishing operation on said shaped part having its ultimate strength properties, for the production of the final shape of said dental prosthetic item (21), wherein during said coarse machining operation a reference block (6) is formed on said blank (3) or on said shaped part (2).

24. A method as defined in claim 23, wherein said reference block (6) is measured following the attainment of the ultimate strength properties and from this measurement of the ultimate strength the shrinkage parameters are determined, the position of said reference block (6) relative to said shaped part having its ultimate strength properties being known to the control software of the 3D shaping operation.

25. A method as defined in claim 23, wherein the scanned data of said reference block having its ultimate strength properties (6) are produced and implemented for optimized control of said finishing operation with reference to speed, accuracy, and/or wear on the machining tools.

26. A method as defined in claims 23, wherein the measurement of said reference block imparted with its ultimate strength properties (6) is carried out by means of a scanning device on a machining unit adapted for the execution of said 3D shaping operation.

27. A method as defined in claim 23, wherein for the purpose of being machined, said blank (3) is attached to a holder (1) having a first connecting geometry.

28. A method as defined in claim 23, wherein the coarse machining operation allows for shrinkage parameters (Xₛ) that will be incurred in the final compacting operation and provides further oversizing to cover the tolerance range of said 3D shaping operation (Tₚ) for said shaped part (2) including the tolerances (Tₛ) of each production batch of blanks (3).

29. A method as defined in claim 28, wherein said oversize (Xₛ, Tₛ, Tₚ) is determined with reference to a particular site on the dental prosthetic item having its ultimate strength properties.

30. A method as defined in claim 23, wherein during said coarse machining operation an unmachined residual region (4) remains on said blank (3).

31. A method as defined in claim 30, wherein said shaped part (2) remains on said residual region (4) after the coarse machining operation has been carried out.

32. A method as defined in claim 23, wherein said shaped part imparted with its ultimate strength properties is attached to a holder having a connecting geometry allowing for shrinkage parameters.

33. A method as defined in claim 23, wherein scanning of said shaped part imparted with its ultimate strength properties is carried out only in certain regions (45, 46, 47) requiring a high degree of precision and the comparison of these data with the data of the coarse machining operation is implemented for generating the machining schedule for said finishing operation while allowing for the shrinkage parameter determined from said comparison.

34. A method as defined in claim 33, wherein said shaped part having its ultimate strength properties is a framework and that scanning is carried out in the region of the internal mating surface (45), the surface (46) mating with the preparation border and the surfaces of the crown copings (47) of a multi-unit restoration to measure the position relatively to each other.

35. A method as defined in claim 23, wherein machining of said shaped part imparted with its ultimate strength properties is carried out only in certain regions (45, 46, 47) requiring a high degree of precision.

36. A method as defined in claim 35, wherein said shaped part having its ultimate strength properties is a framework and that machining is carried out in the region of the internal mating surface (45), the surface (46) mating with the preparation border, and the surfaces of the crown copings (47) of a multi-unit restoration.

37. A method as defined in claim 36, wherein the removal of said shaped part imparted with its ultimate strength properties from said residual region (4) is carried out during the finishing operation.

38. A holder set comprising at least two holders (51, 52), of which each holder has a connecting geometry (53, 54) for a component (55, 56) to be held therein, wherein a first holder (51) has a connecting geometry (53) for a blank (55) not yet imparted with its ultimate strength properties and a second holder (52) has a second connecting geometry (54) for a shaped part (63) that has been carved from the blank (55) and has been imparted with its ultimate strength properties, which first and second connecting geometries (53, 54) differ from each other by the shrinkage parameter of said blank (55) that will be incurred during the final compacting operation.

39. A holder (61) for a blank (62) not yet imparted with its ultimate strength properties and for a shaped part (63) imparted with its ultimate strength properties, wherein a first connecting geometry (64) for said blank (62) not yet imparted with its ultimate strength properties and a second connecting geometry (54) for said shaped part (63) carved from said blank (62) and imparted with its ultimate strength properties are provided, which first and second connecting geometries (64, 65) differ from each other by the shrinkage parameter of said blank (62) that will be incurred during the final compacting operation.

40. A shaped part (2) for the fabrication of a dental prosthetic item, which shaped part (2) is made of a material that has not yet been imparted with its ultimate strength properties, is close to the final shape, but has been carved from a blank (3) with oversize to allow for a shrinkage parameter (Xₛ) that will be incurred during the final compacting operation, which shaped part (2) is further oversized to allow for the tolerance range of the 3D shaping operation (Tₚ) of the dental prosthetic item (21) including the tolerances (Tₛ) of each production batch of blanks (3), wherein a reference body (6) of known position and size is provided on the machined shaped part (2).

41. A shaped part (2) as defined in claim 40, wherein a connecting region for a holder (1) is disposed on the unmachined region of said shaped part.

42. A method for the production of a dental prosthetic item (21), particularly a framework, using a blank (3) to be machined in a material-removing 3D shaping operation and made of a material not yet provided with its ultimate strength properties, comprising a final compacting operation of said shaped part produced in said shaping operation (2) to convert it to a shaped part having its ultimate strength properties, said 3D shaping operation being divided into a coarse machining operation on the blank (3) and a precise finishing operation on the shaped part having its ultimate strength properties, to give the final shape of the dental prosthetic item (21), wherein during said coarse machining of said blank (3) an unmachined residual region (4) having a connecting geometry (53; 64) for the holder remains and that said shaped part (2) remains on said residual region (4) following the coarse machining operation.

43. A method as defined in claim 42, wherein the removal of said shaped part imparted with its ultimate strength properties from said residual region (4) is effected during said finishing operation.

44. A method as defined in claim 43, wherein said blank (3) is attached, for coarse machining thereon, to a holder (51, 61) having a first connecting geometry (53; 64).

45. A method as defined in claim 44, wherein said shaped part that is imparted with its ultimate strength properties is attached, for said finishing operation, to a holder (52; 61) having a connecting geometry (54, 65) which allows for shrinkage parameters.

46. A method as defined in claim 45, wherein the coarse machining operation allows for shrinkage parameters (Xₛ) that will be incurred in the final compacting operation and provides further oversizing to cover the tolerance range of said 3D shaping operation (Tₚ) for said shaped part (2) including the tolerances (Tₛ) of each production batch of blanks (3).

47. A method as defined in claim 46, wherein said oversize (Xs, Ts, Tp) is determined depending on the local position on the dental prosthetic item having its ultimate strength properties.

48. A method as defined in claim 47, wherein during said coarse machining operation a reference block (6) is produced on said blank (3) or on said shaped part (2).

49. A method as defined in claim 48, wherein after the ultimate strength has been imparted, a reference block (6) located on said shaped part is measured, the position of said reference block (6) relative to said shaped part being known to the control software of the 3D shaping operation, and said reference block (6), after the ultimate strength has been imparted thereto, reproduces the shrinkage parameters, preferably in all directions in space.

50. A method as defined in claim 49, wherein the scanned data of said shaped part having its ultimate strength properties and/or of said reference block (6) are produced and implemented to optimize the control of the finishing operation with reference to speed, accuracy, and/or wear on the machining tools.

51. A method as defined in claim 50, wherein the measurement of said shaped part imparted with its ultimate strength properties and/or of said reference block (6) is carried out by means of a scanning device on a machining unit adapted for execution of said 3D shaping operation.

52. A method as defined in claim 51, wherein scanning of said shaped part imparted with its ultimate strength properties is carried out only in certain regions (45, 46, 47) requiring a high degree of precision and the comparison of these data with the data of the coarse machining operation is implemented for generating the machining schedule for said finishing operation while allowing for the shrinkage parameter determined from said comparison.

53. A method as defined in claim 52, wherein said shaped part having its ultimate strength properties is a framework and that scanning is carried out in the region of the internal mating surface (45), the surface (46) mating with the preparation border and the surfaces of the crown copings (47) of a multi-unit restoration.

54. A method as defined in claim 53, wherein machining of said shaped part imparted with its ultimate strength properties is carried out only in certain regions (45, 46, 47) requiring a high degree of precision.

55. A method as defined in claim 54, wherein said shaped part having its ultimate strength properties is a framework and that machining is carried out in the region of the internal mating surface (45), the surface (46) mating with the preparation border, and the surfaces of the crown copings (47) of a multi-unit restoration.

56. A method as defined in claim 55, wherein scanning of said shaped part imparted with its ultimate strength properties is carried out by means of a scanning device on said machining unit.

57. A method for the production of a dental prosthetic item (21), particularly a framework, using a blank (3) to be machined in a material-removing 3D shaping operation and made of a material not yet provided with its ultimate strength properties, comprising a final compacting operation of said shaped part produced in said shaping operation (2), in order to convert it to a shaped part having its ultimate strength properties, said 3D shaping operation being divided into a coarse machining operation on the blank (3) and a precise finishing operation on the shaped part having its ultimate strength properties, to give the final shape of the dental prosthetic item (21), wherein scanning of said shaped part imparted with its ultimate strength properties is carried out only in certain regions (45, 46, 47) requiring a high degree of precision and the comparison of these data with the data of the coarse machining operation is implemented for generating the machining schedule for said finishing operation while allowing for the shrinkage parameter determined from said comparison

58. A method as defined in claim 57, wherein said shaped part having its ultimate strength properties is a framework and that scanning is carried out in the region of the internal mating surface (45), the surface (46) mating with the preparation border and the surfaces of the crown copings (47) of a multi-unit restoration.

59. A method as defined in claim 58, wherein blank (3) is attached, for machining thereof, to a holder (1) having a first connecting geometry.

60. A method as defined in claim 59, wherein the coarse machining operation allows for shrinkage parameters (Xₛ) that will be incurred in the final compacting operation and provides further oversizing to cover the tolerance range of said 3D shaping operation (Tₚ) for said shaped part (2) including the tolerances (Tₛ) of each production batch of blanks (3).

61. A method as defined in claim 60, wherein said oversize (Xₛ, Tₛ, Tₚ) is determined with reference to a particular site on the dental prosthetic item having its ultimate strength properties.

62. A method as defined in claim 61, wherein during said coarse machining operation an unmachined residual region (4) remains on said blank (3).

63. A method as defined in claim 62, wherein said shaped part (2) remains on said residual region (4) following said coarse machining operation.

64. A method as defined in claim 63, wherein during said coarse machining operation a reference block (6) is produced on said blank (3) or on said shaped part (2).

65. A method as defined in claim 64, wherein after the ultimate strength has been imparted, a reference block (6) located on said shaped part is measured, the position of said reference block (6) relative to said shaped part being known to the control software of the 3D shaping operation, which reference block (6), after the ultimate strength has been imparted thereto, reproduces the shrinkage parameters.

66. A method as defined in claim 65, wherein said shaped part imparted with its ultimate strength properties is attached to a holder having a connecting geometry allowing for shrinkage parameters.

67. A method as defined in claim 66, wherein the scanned data of said shaped part having its ultimate strength properties and/or of said reference block (6) are produced and implemented to optimize the control of the finishing operation with reference to speed, accuracy, and/or wear on the machining tools.

68. A method as defined in claim 67, wherein measurement of said shaped part imparted with its ultimate strength properties and/or of said reference block (6) is carried out by means of a scanning device on a machining unit adapted for execution of said 3D shaping operation.

69. A method as defined in claim 68, wherein machining of said shaped part imparted with its ultimate strength properties is carried out only in certain regions (45, 46, 47) requiring a high degree of precision.

70. A method as defined in claim 69, wherein said shaped part having its ultimate strength properties is a framework and that machining is carried out in the region of the internal mating surface (45), the surface (46) mating with the preparation border, and the surfaces of the crown copings (47) of a multi-unit restoration.

71. A method as defined in claim 70, wherein removal of said shaped part imparted with its ultimate strength properties from said residual region (4) is effected during said finishing operation.

72. A method as defined in claim 57, wherein measurement of said shaped part imparted with its ultimate strength properties is carried out by means of a scanning device on the machining unit.

73. A method for the production of a dental prosthetic item (21), particularly a framework, using a blank (3) to be machined in a material-removing 3D shaping operation and made of a material not yet provided with its ultimate strength properties, comprising a final compacting operation of said shaped part produced in said shaping operation (2) to convert it to a shaped part having its ultimate strength properties, said 3D shaping operation being divided into a coarse machining operation on the blank (3) and a precise finishing operation on the shaped part having its ultimate strength properties, to give the final shape of the dental prosthetic item (21), wherein measurement of said shaped part imparted with its ultimate strength properties is carried out by means of a scanning device on a machining unit adapted for the execution of said 3D shaping operation.

74. A method as defined in claim 73, wherein during said coarse machining operation a reference block (6) is formed on said blank (3) or on said shaped part (2) and that after the ultimate strength properties have been imparted, a reference block (6) disposed on said shaped part is measured, the position of said reference block (6) relative to said shaped part being known to the control software of said 3D shaping operation, which reference block (6), after the ultimate strength properties have been imparted thereto, reproduces the shrinkage parameters, preferably in all directions in space.

75. A method as defined in claim 74, wherein said blank (3) is attached, for machining thereof, to a holder (1) having a first connecting geometry.

76. A method as defined in claim 75, wherein the coarse machining operation allows for shrinkage parameters (Xₛ) that will be incurred in the final compacting operation and provides further oversizing to cover the tolerance range of said 3D shaping operation (Tₚ) for said shaped part (2) including the tolerances (Tₛ) of each production batch of blanks (3).

77. A method as defined in claim 76, wherein said oversize (Xₛ, Tₛ, Tₚ) is determined depending on the local position in the dental prosthetic item having its ultimate strength properties.

78. A method as defined in claim 77, wherein during said coarse machining operation an unmachined residual region (4) remains on said blank (3).

79. A method as defined in claim 78, wherein said shaped part (2) remains on said residual region (4) following said coarse machining operation.

80. A method as defined in claim 79, wherein said shaped part imparted with its ultimate strength properties is attached to a holder having a connecting geometry allowing for shrinkage parameters.

81. A method as defined in claim 80, wherein the scanned data of said shaped part having its ultimate strength properties and/or of said reference block (6) are produced and implemented to optimize the control of the finishing operation with reference to speed, accuracy, and/or wear on the machining tools.

82. A method as defined in claim 81, wherein scanning of said shaped part imparted with its ultimate strength properties is carried out only in certain regions (45, 46, 47) requiring a high degree of precision and the comparison of these data with the data of the coarse machining operation is implemented for generating the machining schedule for said finishing operation while allowing for the shrinkage parameter determined from said comparison.

83. A method as defined in claim 82, wherein said shaped part having its ultimate strength properties is a framework and that scanning is carried out in the region of the internal mating surface (45), the surface (46) mating with the preparation border and the surfaces of the crown copings (47) of a multi-unit restoration.

84. A method as defined in claim 83, wherein machining of said shaped part imparted with its ultimate strength properties is carried out only in certain regions (45, 46, 47) requiring a high degree of precision.

85. A method as defined in claim 84, wherein said shaped part having its ultimate strength properties is a framework and that machining is carried out in the region of the internal mating surface (45), the surface (46) mating with the preparation border, and the external surfaces of the crown copings (47) of a multi-unit restoration.

86. A method as defined in claim 85, wherein removal of said shaped part imparted with its ultimate strength properties from said residual region (4) is effected during said finishing operation.

87. A method as defined in claim 83, wherein scanning of said shaped part imparted with its ultimate strength properties is effected by means of a scanning device on the machining unit.

88. A shaped part (2) for the production of a dental prosthetic item, which shaped part (2) is made of a material that has not yet been imparted with its ultimate strength properties, is close to the final shape, but has been carved from a blank (3) with oversize to allow for a shrinkage parameter (Xₛ) that will be incurred during the final compacting operation, wherein said shaped part (2) is further oversized to allow for the tolerance range of the 3D shaping operation (Tₚ) of the dental prosthetic item (21) including the tolerances (Tₛ) of each production batch of blanks (3).

89. A dental prosthetic item, produced from a densely sintered shaped part as defined in claim 88, wherein said dental prosthetic item is adapted to conform to the basic dimensions X₀ by at least partial machining of said shaped part at least in subregions and that said unmachined surfaces of said dental prosthetic item are oversized relative to said basic dimensions X₀ in order to cover the tolerance range of said 3D shaping operation and the tolerances of each production batch of blanks.
